(19) United States
(12) Patent Application Publication
(10) Pub. No.: US 2025/0227631 A1
(43) Pub. Date: Jul. 10, 2025

(54) Enabling Time Synchronization and Time Resiliency Service via Subscription

(71) Applicant: Telefonaktiebolaget LM Ericsson (publ), Stockholm (SE)

(72) Inventors: Marilet De Andrade Jardim, Kista (SE); Aleksejs Udalcovs, Stockholm (SE)

(21) Appl. No.: 18/847,787

(22) PCT Filed: Mar. 22, 2023
(86) PCT No.: PCT/IB2023/052823

§ 371 Date: Sep. 17, 2024

Related U.S. Application Data
(60) Provisional application No. 63/322,301, filed on Mar. 22, 2022.

(51) Int. Cl. H04W 56/00; H04W 8/20

(52) U.S. Cl. CPC H04W 56/001; H04W 8/20

(57) ABSTRACT

A method and apparatus for authorizing time synchronization service request or time synchronization service request with time resiliency from an Application Function in a communication system is provided. A time synchronization service network function supporting time synchronization service in the communication system receives a request originated from the application function (AF) to request for time synchronization service or alternatively time synchronization with time resiliency service for a UE or a group of UEs. The time synchronization service network function obtains subscription data for the UE or the group of UEs indicating whether the request for time synchronization from the AF is authorized or not. If authorized the request is allowed to proceed else it rejects the request from the AF.

### RELATED APPLICATIONS

This application claims the benefit of provisional patent application Ser. No. 63/322,301, filed on Mar. 22, 2022, the disclosure of which is hereby incorporated herein by reference in its entirety.

### TECHNICAL FIELD

The present disclosure relates to time synchronization services in a telecommunication system.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Third Generation Partnership Project (3GPP) Technical Specification (TS) 23.501 V17.3.0 and TS 23.502 V17.3.0 define, among other things, aspects related to Fifth Generation system, 5G System, 5GS, features enabling Time Sensitive Communications and Time Synchronization services. To enable Time synchronization in for example a 5G system, 3GPP TS23.501 V17.3.0 describes the 5GS as being able to operate in one or multiple Point Precision Time Protocol (PTP) instances and each PTP instance can operate:
1) as time-aware system as described in IEEE Std 802.1AS,
2) as Boundary Clock as described in IEEE Std 1588, provisioned by the profiles supported by this 3GPP specification including SMPTE Profile for Use of IEEE Std 1588 Precision Time Protocol, PTP, in Professional Broadcast Applications ST 2059-2:2015,
3) as peer-to-peer Transparent Clock as described in IEEE Std 1588, provisioned by the profiles supported by this 3GPP specification including SMPTE Profile for Use of IEEE Std 1588 Precision Time Protocol in Professional Broadcast Applications ST 2059-2:2015; or
4) as end-to-end Transparent Clock as described in IEEE Std 1588, provisioned by the profiles supported by this 3GPP specification including SMPTE Profile for Use of IEEE Std 1588 Precision Time Protocol in Professional Broadcast Applications ST 2059-2:2015.

According to 3GPP TS 23.501 V17.3.0 clauses 5.27.1.8 and 5.27.1.9, Time synchronization service can also be enabled by using access stratum time distribution method, where an Application Function (AF) can influence the timing distribution between the RAN and the UE, and the UE/DS-TT may distribute the timing information externally via implementation specific means.

FIG. 1 depicts the 3GPP release 17 reference point representations of the 5G System enabling Time Sensitive Communication and Time synchronization. The architecture includes a Device side Time Sensitive Network, TSN, translator, DS-TT, a Network Side TSN translator, NW-TT. The TSN Translator functionality provides interoperation between TSN Systems and 5G System both for user plane and control plane. The architecture also includes a Time Sensitive Communication (TSC) and Time Synchronization function (TSCTSF) that controls the DS-TT(s) and NW-TT for the general (g) PTP based time synchronization service based on IEEE 802.1AS. As part of 3GPP Release 18, a technical report TR 23.700-25 V.0.1.0 studying timing resiliency and TSC and URLLC enhancements is being developed.

### SUMMARY

There currently exist certain challenge(s). More specifically, the 3GPP Release 18 TR 23.700-25 describes a number of key issues to study. Key issue #3 is about the control of time synchronization based on UE subscription and suggests introducing a subscription parameter for time synchronization and enforcing it in 5GS. The issue is the existing solution does not address how to control time resiliency with time synchronization.

Certain aspects of the present disclosure and their embodiments may provide solutions to the aforementioned or other challenges. Embodiments of the solutions described herein propose to use subscription data as enabler of the time synchronization service in 5GS.

The embodiments described herein are explained for using the timing synchronization architecture and services provided in 5G system (5GS), however, it is apparent that the solution can be applied to any system supporting such services including future 6G systems, but not limited thereto.

Embodiments of the present disclosure provide solution(s) enabling control of timing synchronization and a more complex timing resiliency service.

In accordance with some embodiments, a method implemented in a time synchronization service network function (e.g., TSCTSF in 5G system) for authorizing a request from an Application function (AF) a request for time synchronization service or time synchronization service with time resiliency is provided.

The method comprises the step of receiving a request for time synchronization for a UE or a group of UEs, originated from an application function (AF). The request may be received via a Network Exposure Function (NEF) or directly from the AF. Alternatively, the request for time synchronization service from the AF further comprises a request for time synchronization with time resiliency service. The request for time synchronization or time synchronization with time resiliency may include parameter related to requested timing resiliency service.

The method further comprises the step of obtaining subscription data for the UE or the group of UEs indicating whether the request for time synchronization from the AF is authorized to proceed. For example, the time synchronization service network function obtains the subscription data by sending a request to a User Data Management (UDM) node to request the subscription data related to time synchronization service or Time synchronization with Time resiliency service (if requested by the AF) and receiving the subscription data indicating whether time synchronization service is authorized, or alternatively whether Time synchronization with Time resiliency service is authorized. In one example, the subscription data may comprise an indication that the time synchronization service or the time synchronization with time resiliency service is enabled or disabled. Alternatively, if the subscription data includes time synchronization or time synchronization with time resiliency that match the request from the AF, the time synchronization network function may determine the authorization of the request from the AF if the request matches the subscription.

The method further comprises the step of determining from the obtained subscription data for the UE or the group of UEs that the request for time synchronization or alternatively the time synchronization with time resiliency from the AF is not authorized, in which case the time synchronization service network function rejects the request for time synchronization service or time synchronization with time resiliency received from the from the AF. A reject message may be sent back to the AF. In another example, if the time synchronization service network function determines the subscription data authorize the request for time synchronization service/time synchronization with time resiliency from the AF, it will proceed with activating/providing time synchronization service or time synchronization with time resiliency service for the UE or the group of UEs.

In one embodiment, the time synchronization service network function further subscribes at the User Data management node to receive any changes to the subscription to time synchronization or Time synchronization with Time resiliency service. In another example, the time synchronization service network function may subsequently receive notification from the UDM or the AF to disable time resiliency service, and upon receiving the notification, deactivating the time resiliency service.

In another embodiment, the time synchronization service network function performs the step of receiving a notification from the UDM or the AF to disable time synchronization service, and upon receiving the notification, it deactivates the time synchronization service and the timing resiliency service if the timing resiliency was previously authorized and/or activated.

In one embodiment, a node implementing a time synchronization service network function is configured to implement any of embodiments described herein.

In another embodiment, a node comprising one or more processor and memory for storing instructions which when executed by the one or more processors of the node implementing a time synchronization service will perform any of embodiments described herein.

In another embodiment, a Computer Readable medium containing program instructions causing one or more processors of a node implementing a time synchronization service to perform any of the embodiments described herein.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrate example embodiments in which the cellular communication system of FIG. 1 is a Fifth Generation (5G) System (5GS);

FIG. 2 illustrates one example of a cellular communications system in which embodiments of the present disclosure can be implemented;

FIG. 3 il illustrate the service-based interface (SBI) architecture view of the (5G) System (5GS) of FIG. 1;

FIG. 4 illustrates a procedure in accordance with one embodiment of the present disclosure;

FIG. 5A illustrates another procedure in accordance another embodiment of the present disclosure;

FIG. 5B illustrates a flow chart of a method in time synchronization service network function in accordance with some embodiments of the present disclosure;

FIGS. 6, 7, and 8 are schematic block diagrams of example embodiments of a network node.

### DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node/server/distributed servers/dedicated platform that implements one or more core network function also referred to as Network Function. Some examples of Network Function include, e.g., a Mobility Management Entity (MME), a Packet Data Network Gateway (P-GW), a Service Capability Exposure Function (SCEF), a Home Subscriber Server (HSS), or the like. Some other examples of a Network Function include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), a TSCTSF, or the like. In general, a network function can be implemented either as a network element on a dedicated hardware, as a software instance running on a dedicated hardware, or as a virtualized function instantiated on an appropriate platform, e.g. on a cloud infrastructure. Note that a UPF may include a NW-TT.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection. The communication device may include or connect a DS-TT.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection. The wireless communication device may include or connect a DS-TT.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

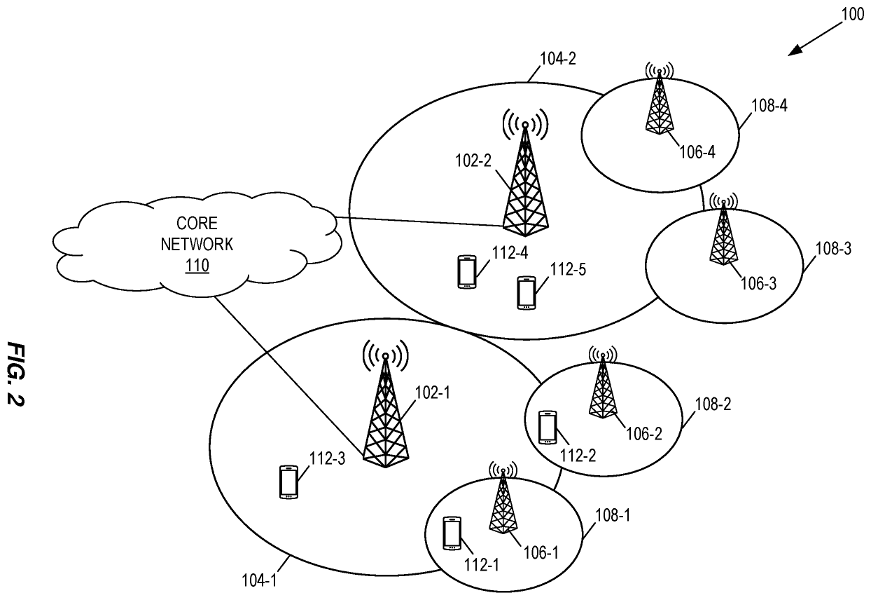

FIG. 2 illustrates one example of a cellular communications system 100 in which embodiments of the present disclosure may be implemented. In the embodiments described herein, the cellular communications system 100 is a 5G system (5GS) including a Next Generation RAN (NG-RAN) and a 5G Core (5GC); however, the present disclosure is not limited thereto. In this example, the RAN includes base stations 102-1 and 102-2, which in the 5GS include NR base stations (gNBs) and optionally next generation eNBs (ng-eNBs) (e.g., LTE RAN nodes connected to the 5GC), controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or RRHs, or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5G System (5GS) is referred to as the 5GC. The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs and as such sometimes referred to herein as UEs 112, but the present disclosure is not limited thereto.

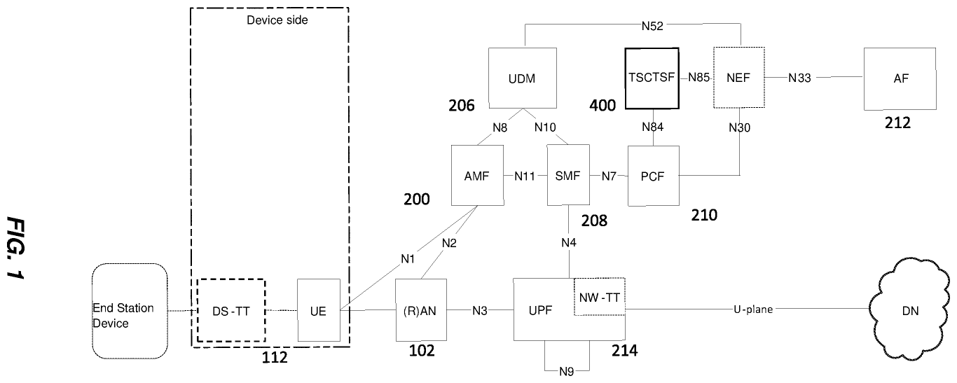

As indicated, FIG. 1 illustrates a wireless communication system represented as a 5G System architecture enabling Time Sensitive Communication and Time synchronization composed of core Network Functions where interaction between any two NFs is represented by a point-to-point reference point/interface. FIG. 2 can be viewed as one particular implementation of the system 100 of FIG. 2.

Seen from the access side the 5G system architecture shown in FIG. 1 comprises a plurality of UEs 112 connected to either a RAN 102 or an Access Network (AN) as well as an AMF 200. Typically, the R (AN) 102 comprises base stations, e.g. such as eNBs or gNBs or similar. Seen from the core network side, the 5GC NFs shown in FIG. 1 include a UDM 206, an AMF 200, a SMF 208, a PCF 210, a TSCTSF (400), an Application Function (AF) 212, a User Data Record (UDR, not shown), an NSSF and an AUSF.

Reference point representations of the 5G network architecture are used to develop detailed call flows in the normative standardization. The N1 reference point is defined to carry signaling between the UE 112 and AMF 200. The reference points for connecting between the AN 102 and AMF 200 and between the AN 102 and UPF 214 are defined as N2 and N3, respectively. There is a reference point, N11, between the AMF 200 and SMF 208, which implies that the SMF 208 is at least partly controlled by the AMF 200. N4 is used by the SMF 208 and UPF 214 so that the UPF 214 can be set using the control signal generated by the SMF 208, and the UPF 214 can report its state to the SMF 208. N9 is the reference point for the connection between different UPFs 214. N30 is the Reference point between PCF 210 and the NEF. N33 is the Reference point between NEF and AF 212. N84 is the Reference point between TSCTSF and PCF. N85 is the Reference point between TSCTSF and NEF. N86 is the Reference point between TSCTSF and AF (not shown).

The 5GC network aims at separating UP and CP. The UP carries user traffic while the CP carries signaling in the network. In FIG. 1, the UPF 214 is in the UP that can host a NW-TT and all other NFs, i.e., the AMF 200, SMF 208, PCF 210, AF 212, and UDM 206, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 200 and SMF 208 are independent functions in the CP. Separated AMF 200 and SMF 208 allow independent evolution and scaling. Other CP functions like the PCF 210 and AUSF 204 can be separated as shown in FIG. 2. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

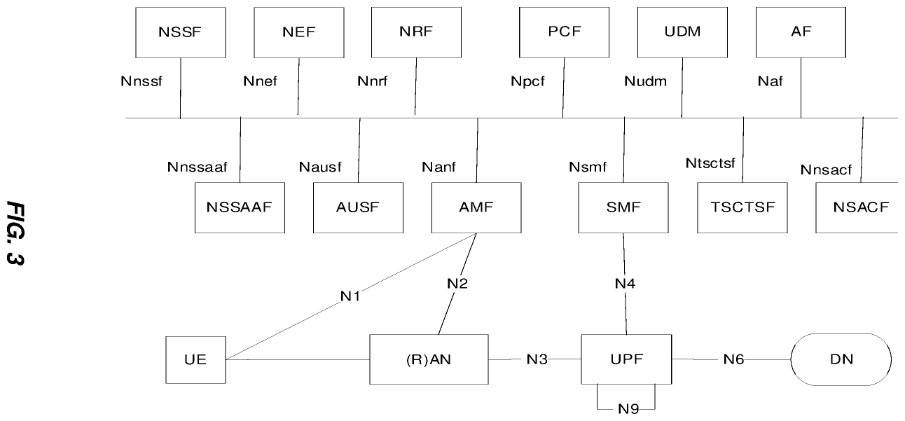

FIG. 3 illustrates a 5G network architecture using service-based interfaces between the NFs in the CP, instead of the point-to-point reference points/interfaces used in the 5G network architecture of FIG. 1. However, the NFs described above with reference to FIG. 1 correspond to the NFs shown in FIG. 3. The service(s) etc. that a NF provides to other authorized NFs can be exposed to the authorized NFS through the service-based interface. In FIG. 3 the service based interfaces are indicated by the letter “N” followed by the name of the NF, e.g. Namf for the service based interface of the AMF 200 and Nsmf for the service based interface of the SMF 208, etc. It should be clarified that all NFs depicted in FIG. 1 can interact with the NEF and the NRF of FIG. 3 as necessary, though not explicitly indicated in FIG. 1.

Some properties of the NFs shown in FIGS. 1 and 3 may be described in the following manner. The AMF 200 provides UE-based authentication, authorization, mobility management, etc. A UE 112 even using multiple access technologies is basically connected to a single AMF 200 because the AMF 200 is independent of the access technologies. The SMF 208 is responsible for session management and allocates Internet Protocol (IP) addresses to UEs. It also selects and controls the UPF 214 for data transfer. If a UE 112 has multiple sessions, different SMFs 208 may be allocated to each session to manage them individually and possibly provide different functionalities per session. The AF 212 provides information on the packet flow to the PCF 210 responsible for policy control in order to support QoS. The AF 212 can also interact via the NEF using an exposure API to request exposed services, and it may interact directly with a TSCTSF 400 or indirectly via the NEF, if AF is 3rd party, to provide individual traffic pattern parameters. The TSCTSF 400 creates the TSC Assistance Container based on the received individual traffic pattern parameters.

Note that although this document describes using the 5G system to enabling Time Sensitive Communication and Time synchronization, any other system supporting can be used, be it 6G or otherwise. Also although the embodiments are described using the 5G NFs TSCTSF and UDM, it will be apparent to a skilled person that the embodiments described herein apply to any equivalent functions in other systems.

Certain aspects of the present disclosure for controlling timing resiliency by subscription and their embodiments may provide solutions to the aforementioned or other challenges. Embodiments of the solutions described herein are based on the following principles:
A new subscription data type for time synchronization service is added. The new subscription data type includes authorization information for both time synchronization and timing resiliency services. The new Time Synchronization Subscription data type, is provisioned in UDM/UDR for a UE or group of UEs and corresponding Data Network Name, DNN/network slice, S-NSSAI.
Upon receiving AF request from the AF 212 for time synchronization, which may include a parameter related to timing resiliency service (via NEF if AF is 3rd party), the TSCTSF 400 will use Nudm_SDM_Get service operation to retrieve subscription data about time synchronization for a UE or group of UEs (based on AF request).
For using Nudm_SDM_Get, TSCTSF 400 will include its NF identifier (NF ID), Time Synchronization Subscription data type, DNN/S-NSSAI and the key for the subscription data type: SUPI/Internal Group Identifier (if AF 212 is in the operator domain), or GPSI/External Group Identifier (if 3rd party AF).
If TSCTSF 400 receives a subscription data (from UDM) that corresponds to the requested service, the TSCTSF 400 proceeds with the service activation as previously defined.
If the subscription data does not correspond to the requested service by the AF, then the TSCTSF does not activate the service.

Additionally, the TSCTSF 400 may subscribe to UDM (using Nudm_SDM_Subscribe service operation) to get changes in the time synchronization and timing resiliency subscription data, in which case:
if a subscription to time synchronization service is added, then the TSCTSF 400 will proceed to activate the service;
if subscription to timing resiliency is added in addition to time synchronization subscription, then the time synchronization service is updated to support timing resiliency or timing resiliency is activated, respectively;
if subscription to time synchronization is removed, then the corresponding service is deactivated and timing resiliency is also deactivated if it was also active (unless AF 212 had requested for deactivation first, or temporal validity condition had expired first);
if timing resiliency alone is removed, then this service is deactivated (unless AF had requested for deactivation first, or temporal validity condition had expired first).
The corresponding responses are provided to AF 212.
   For using Nudm_SDM_subscribe, TSCTSF 400 will include Time Synchronization Subscription data type indicating time synchronization and/or time resiliency data, DNN/S-NSSAI and the key for the subscription data type: SUPI/Internal Group Identifier (if AF 212 is in the operator domain), or GPSI/External Group Identifier (if 3rd party AF).

When the time synchronization service is deactivated (via AF request, or in case subscription to time synchronization is removed in UDM), then the TSCTSF 400 may unsubscribe UDM (using Nudm_SDM_Unsubscribe service operation), if it had previously subscribed to UDM.

TSCTSF Interaction with UDM

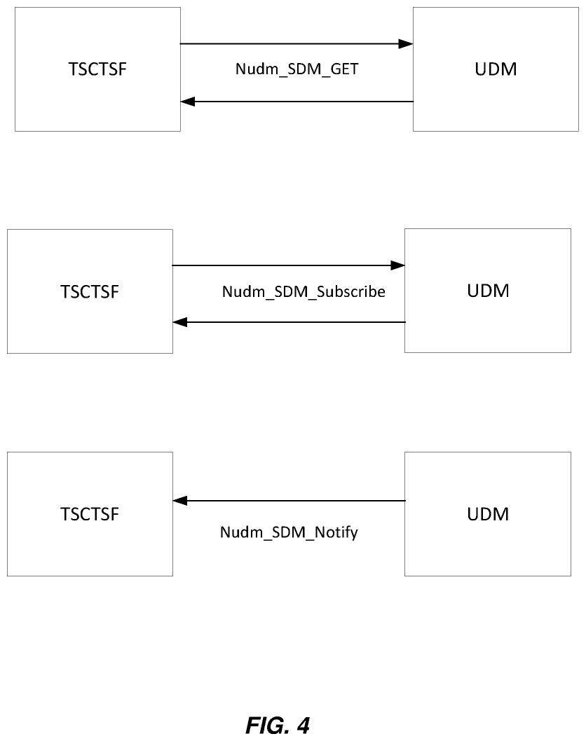

FIG. 4 illustrates an embodiment of the present disclosure wherein the TSCTSF 400 interacts with the UDM to retrieve time synchronization and time resiliency subscriptions and subscribe to any changes thereof.

The TSCTSF requests the time synchronization and/or time resiliency synchronization data during a service activation as described in subsequent embodiment. The TSCTSF uses an Application Programming Interface (API) with the UDM (e.g., Nudm_SDM_Get) to request the subscription to the services. The TSCTSF will include its NF ID, (new) Time Synchronization Subscription data type (Time synchronization and/or Time resiliency), DNN/S-NSSAI and the key for the subscription data type: SUPI/Internal Group Identifier (if AF is in the operator domain), or GPSI/External Group Identifier (if 3^{rd} party AF).

If the TSCTSF receives a subscription data (from UDM) that corresponds to the requested service by the AF (i.e., AF requesting time synchronization which may include additional time resiliency, the TSCTSF proceeds with the service activation as will be described below.

If the subscription data does not correspond to the requested service by the AF (requested directly or via the NEF), then the TSCTSF does not activate the service requested by the AF.

In addition to retrieving the subscription, the TSCTSF may subscribe to UDM (using Nudm_SDM_Subscribe service operation) to get changes to the time synchronization and timing resiliency subscription data, in which case:
if a subscription to time synchronization service is added, then the TSCTSF will proceed to activate the service;
if subscription to timing resiliency is added in addition to time synchronization subscription, then the time synchronization service is updated to support timing resiliency or timing resiliency is activated, respectively;
if subscription to time synchronization is removed, then the corresponding service is deactivated and timing resiliency is also deactivated if it was also active (unless AF had requested for deactivation first, or temporal validity condition had expired first);
if timing resiliency alone is removed, then this service is deactivated (unless AF had requested for deactivation first, or temporal validity condition had expired first).
The corresponding responses are provided to AF.
Any changes to the subscription data is indicated to the TSCTSF by the UDM via the notification API, Nudm_SDM_notify. The change is either to authorize a previously non-authorized time synchronization service or time resiliency service. The API can also deauthorize, i.e., remove the service as indicated above.

When the TSCTSF subscribes to Time synchronization and time resiliency subscription change using for example Nudm_SDM_subscribe, the TSCTSF will include Time Synchronization Subscription data type, DNN/S-NSSAI and the key for the subscription data type: SUPI/Internal Group Identifier (if AF is in the operator domain), or GPSI/External Group Identifier (if 3^{rd} party AF).

Any changes to Time synchronization and/or time resiliency subscription is provided to the TSCTSF via a notify message from the UDM.

If the time synchronization service is deactivated (via AF request, or in case subscription to time synchronization is removed in UDM), then the TSCTSF unsubscribes for notifications from UDM, if it had previously subscribed to UDM.

### Time Synchronization Activation Procedures

The time synchronization and time resiliency procedure can be activated using similar procedure described in 3GPP TS 23.502 clause 4.15.9 for time synchronization activation.

3GPP TS 23.502 states that the time synchronization activation procedure is used by the AF to activate, modify or deactivate the (g) Precision Time Protocol, gPTP, instances in 5GS (see clause 4.15.9.3). A procedure is also available to activate access stratum time distribution method, where time distribution from RAN to UE is influenced by AF, and UE/DS-TT may distribute the timing information externally via implementation specific means and not necessarily PTP (see clause 4.15.9.4 in 3GPP TS 23.502).

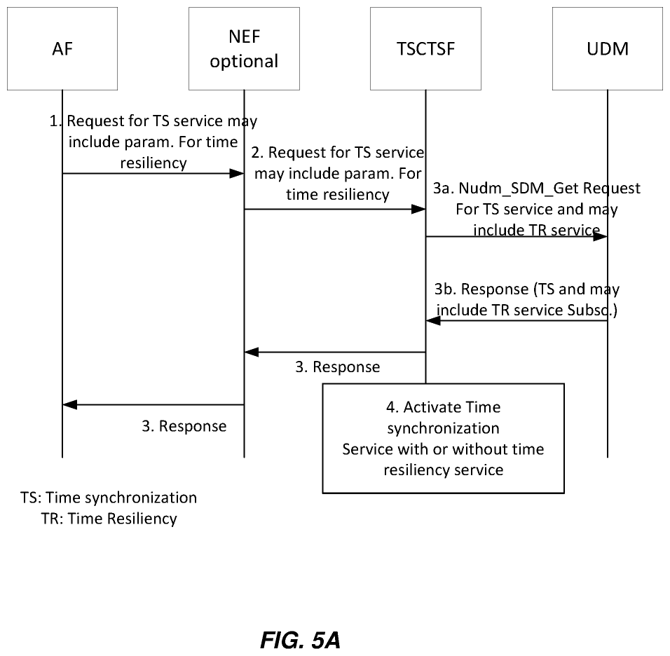

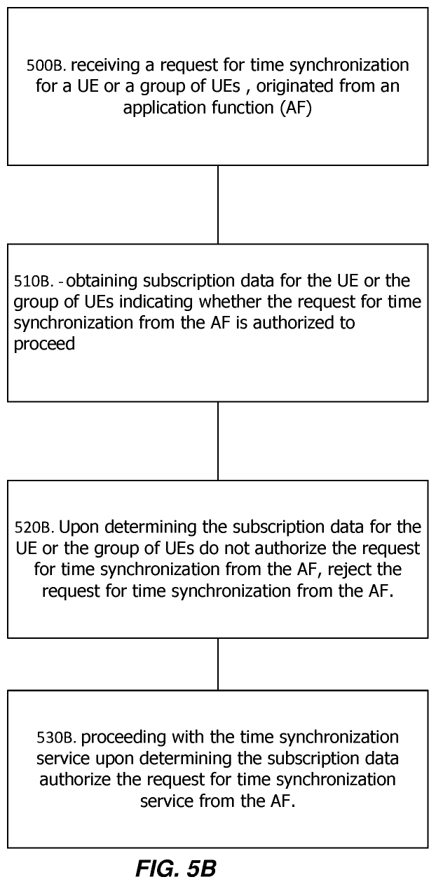

In this embodiment illustrated in FIG. 5A, the AF may activate the time synchronization service or time synchronization service with time resiliency service using the Nnef_TimeSynchronization_ConfigCreate service operation or the like.

Step 1: The AF creates a time synchronization service configuration for a PTP instance, to request time synchronization service, by invoking Nnef_TimeSynchronization_ConfigCreate service operation for a UE or a group of UEs. The request includes information indicating time synchronization and may include parameters related to time resiliency service (if request is for time synchronization service with time resiliency service). The request could contain a Subscription Correlation ID and user-plane node ID as a reference to the target of the UEs and AF-sessions.

Step 2: The NEF (optional, only if AF is 3^{rd} party) authorizes the request. After successful authorization, the NEF invokes the Ntsctsf_TimeSynchronization_ConfigCreate service operation with the corresponding TSCTSF, with the parameters as received from the AF.

The AF that is part of operator's trust domain may invoke the services directly with TSCTSF.

Step 3a: The TSCTSF interacts with the UDM to get time synchronization and optionally time resiliency subscription data.

Step 3b: The TSCTSF receives the subscription data for time synchronization.
if the subscription data indicates subscription to time synchronization service is enabled, then the TSCTSF will proceed to activate the service;
if the subscription data indicates subscription to timing resiliency and timing resiliency service is enabled or authorized in addition to time synchronization, then the time synchronization service is updated to support timing resiliency or timing resiliency is activated, respectively. If timing synchronization service is disabled or not authorized then timing resiliency is also not authorized, however UDM can authorize time synchronization service while not authorizing time resiliency. Time resiliency service can only be authorized if time synchronization service is authorized.

Step 3: The TSCTSF responds with the Ntsctsf_TimeSynchronization_ConfigCreate response. The Ntsctsf_TimeSynchronization_ConfigCreate response includes a PTP instance reference.

Step 4: rest of the activation procedure is as described in TS 23.502, V. 17.3.0, clause 4.15.9.3, with the change that if time resiliency subscription is provided from UDM indicating time resiliency is enabled, then time synchronization service is updated to support timing resiliency or timing resiliency is activated.

In step 3a or in subsequent step (not shown in the figure), the TSCTSF can subscribe to UDM for any changes to the subscriptions related to time synchronization and time resiliency.

FIG. 5B illustrates a method implemented in a time synchronization service network function (e.g., TSCTSF in 5G system) in accordance with some embodiments.

At step 500B the time synchronization service network function performs the step of receiving a request for time synchronization for a UE or a group of UEs, originated from an application function (AF). The request may be received via a Network Exposure Function (NEF) or directly from the AF. Alternatively, the request for time synchronization service from the AF further comprises a request for time synchronization with time resiliency service. The request for time synchronization or time synchronization with time resiliency may include parameter related to requested timing resiliency service.

At step 510B, the time synchronization service network function performs the step of obtaining subscription data for the UE or the group of UEs indicating whether the request for time synchronization from the AF is authorized to proceed. For example the time synchronization service network function obtains the subscription data by sending a request to a User Data Management (UDM) node to request the subscription data related to time synchronization service or Time synchronization with Time resiliency service (if requested by the AF) and receiving the subscription data indicating whether time synchronization service is authorized, or whether Time synchronization with Time resiliency service is authorized. The subscription data may comprise an indication that the time synchronization service or the time synchronization with time resiliency service is enabled or disabled. Alternatively, if the subscription data includes time synchronization or time synchronization with time resiliency that match the request from the AF, the time synchronization network function may determine the authorization of the request from the AF if the request matches the subscription.

At step 520B, if the time synchronization service network function determines from the obtained subscription data for the UE or the group of UEs at step 510B that it should not authorize the request for time synchronization or time synchronization with time resiliency from the AF, the time synchronization service network function rejects the request for time synchronization received from the from the AF. A reject message may be sent back to the AF. On the other hand, if the time synchronization service network function determines the subscription data authorize the request for time synchronization service/time synchronization with time resiliency from the AF, it will proceed (step 530B) with activating/providing time synchronization service or time synchronization with time resiliency service for the UE or group of UEs.

In one embodiment, the time synchronization service network function further subscribes at the User Data management node to receive any changes to the subscription to time synchronization or Time synchronization with Time resiliency service. In another example, the time synchronization service network function may subsequently receive notification from the UDM or the AF to disable time resiliency service, and upon receiving the notification, deactivating the time resiliency service.

In another embodiment, the time synchronization service network function performs the step of receiving a notification from the UDM or the AF to disable time synchronization service, and upon receiving the notification, it deactivates the time synchronization service and it also deactivates the timing resiliency service if the timing resiliency was previously authorized and/or activated (if time synchronization with timing resiliency was previously activated).

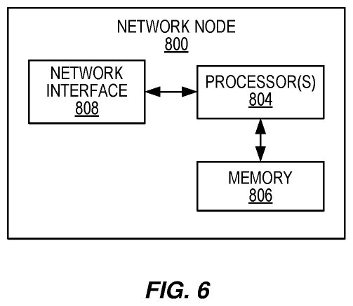

FIG. 6 is a schematic block diagram of a network node 800 according to some embodiments of the present disclosure. Optional features are represented by dashed boxes. The network node 800 may be, for example, a core network node that implements a NF (e.g., AMF 200, SMF 206, TSCTSF 400, UDM, UDR, AF, UPF, or the like). As illustrated, the network node 800 includes a one or more processors 804 (e.g., Central Processing Units (CPUs), Application Specific Integrated Circuits (ASICs), Field Programmable Gate Arrays (FPGAs), and/or the like), memory 806, and a network interface 808. The one or more processors 804 are also referred to herein as processing circuitry. The one or more processors 804 operate to provide one or more functions of the network node 800 as described herein (e.g., one or more functions of the AMF 200, SMF 206, TSCTSF 400, UDM, UDR, AF, UPF, or the like, as described herein). In some embodiments, the function(s) are implemented in software that is stored, e.g., in the memory 806 and executed by the one or more processors 804.

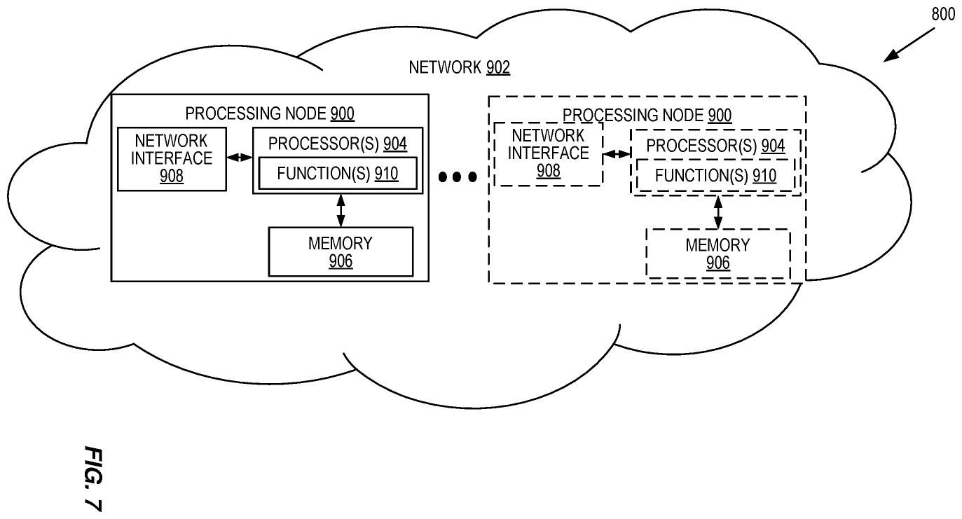

FIG. 7 is a schematic block diagram that illustrates a virtualized embodiment of the network node 800 according to some embodiments of the present disclosure. Again, optional features are represented by dashed boxes. As used herein, a “virtualized” network node is an implementation of the network node 800 in which at least a portion of the functionality of the network node 800 is implemented as a virtual component(s) (e.g., via a virtual machine(s) executing on a physical processing node(s) in a network(s)). As illustrated, in this example, the network node 800 includes one or more processing nodes 900 coupled to or included as part of a network(s) 902. Each processing node 900 includes one or more processors 904 (e.g., CPUs, ASICs, FPGAS, and/or the like), memory 906, and a network interface 908. In this example, functions 910 of the network node 800 described herein (e.g., one or more functions of the AMF 200, SMF 206, TSCTSF 400, UDM, UDR, AF, UPF, or the like, as described herein) are implemented at the one or more processing nodes 900 or distributed across the two or more processing nodes 900 in any desired manner. In some particular embodiments, some or all of the functions 910 of the network node 800 described herein are implemented as virtual components executed by one or more virtual machines implemented in a virtual environment(s) hosted by the processing node(s) 900.

In some embodiments, a computer program including instructions which, when executed by at least one processor, causes the at least one processor to carry out the functionality of the network node 800 or a node (e.g., a processing node 900) implementing one or more of the functions 910 of the network node 800 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

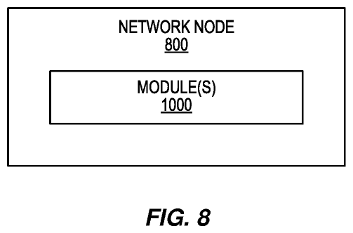

FIG. 8 is a schematic block diagram of the network node 800 according to some other embodiments of the present disclosure. The network node 800 includes one or more modules 1000, each of which is implemented in software. The module(s) 1000 provide the functionality of the network node 800 described herein. This discussion is equally applicable to the processing node 900 of FIG. 7 where the modules 1000 may be implemented at one of the processing nodes 900 or distributed across multiple processing nodes 900.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

A method in a first network node implementing a first network function for supporting time synchronization service in a communication system, comprising:
Receiving a request for time synchronization for a UE or a group of UEs, originated from an application function (AF), the request may include parameter related timing resiliency service;
Sending a request to a User Data Management (UDM) node to request the subscription data related to time synchronization and/or time resiliency service;
Receiving the subscription data indicating whether time synchronization service is authorized, or whether Time synchronization with Time resiliency service is authorized,
Activating the time synchronization service or the time synchronization service with time resiliency service in accordance with the subscription data.

The method of embodiment 1, wherein the method further comprises subscribing at the User Data management node to receive any changes to the subscription to time synchronization and/or time resiliency service.

The method of embodiment 1 or 2 further comprising, receiving a notification from the UDM or the AF to disable time resiliency service, and upon receiving the notification, deactivating the time resiliency service.

The method of embodiment 1 or 2 further comprising, receiving a notification from the UDM or the AF to disable time synchronization service, and upon receiving the notification, deactivating the time synchronization service and the timing resiliency service if the timing resiliency was previously authorized and/or activated.

A node implementing the first network function configured to implement any of embodiments 1 to 4.

A node comprising one or more processor and memory for storing instructions which when executed by the one or more processors will perform any of the embodiments 1 to 4.

A Computer Readable medium containing program instructions for causing a computer to perform the method of embodiments 1 to 4.

A method in a second network node implementing a second network function for supporting subscription to time synchronization service in a communication system, comprising:
receiving a request to provide to a first network node a subscription data related to time synchronization service or time synchronization with time resiliency service for a UE or a group of UEs;
sending the subscription data indicating whether time synchronization service is authorized, or whether Time synchronization with Time resiliency service is authorized.

The method of embodiment 8, wherein the method further comprises receiving a subscription to report any changes to the subscription to time synchronization or time synchronization with Time resiliency service.

The method of embodiment 8 or 9 further comprising, sending a notification to disable time resiliency service or time synchronization service or both.

A node implementing the second network function configured to implement any of embodiments 8 to 10.

A node comprising one or more processor and memory for storing instructions which when executed by the one or more processors will perform any of the embodiments 8 to 10.

A Computer Readable medium containing program instructions for causing a computer to perform the method of embodiments 8 to 10.

Those skilled in the art will recognize improvements and modifications to the embodiments of the present disclosure. All such improvements and modifications are considered within the scope of the concepts disclosed herein.

1-11. (canceled)

12. A method for supporting a time synchronization service in a communication system provided by a first network node that implements a time synchronization service network function, the method comprising:
receiving a request for time synchronization for a user equipment (UE) or a group of UEs, originated from an application function (AF);
obtaining subscription data for the UE or the group of UEs indicating whether the request for time synchronization from the AF is authorized to proceed;
upon determining the subscription data for the UE or the group of UEs do not authorize the request for time synchronization from the AF, rejecting the request for time synchronization from the AF; and
proceeding with the time synchronization service upon determining the subscription data authorize the request for time synchronization service from the AF.

13. The method of claim 12, wherein the request for time synchronization service from the AF further comprises a request for time synchronization with time resiliency service and the subscription data indicate whether the request for time synchronization with time resiliency is authorized or not.

14. The method of claim 12, wherein the request for time synchronization or time synchronization with time resiliency include parameters related to requested timing resiliency service.

15. The method of claim 12, wherein the step of obtaining the subscription data further comprises:
sending a request to a User Data Management (UDM) node to request the subscription data related to time synchronization service or time synchronization with time resiliency service; and
receiving the subscription data indicating whether time synchronization service is authorized, or whether time synchronization with time resiliency service is authorized.

16. The method of claim 12, wherein the subscription data comprises an indication that the time synchronization service or the time synchronization with time resiliency service is enabled or disabled.

17. The method of claim 12, wherein the method further comprises subscribing at the UDM node to receive any changes to the subscription to time synchronization or time synchronization with time resiliency service.

18. The method of claim 12, further comprising, receiving a notification from the UDM node or the AF to disable time synchronization service, and upon receiving the notification, deactivating the time synchronization service and deactivating the timing resiliency service if the time synchronization with timing resiliency was previously authorized and/or activated.

19. A node configured to provide a time synchronization service, the node comprising:
one or more processors; and
memory storing computer program instructions which, when executed by the one or more processors, configure the one or more processors to:
receive a request for time synchronization for a user equipment (UE) or a group of UEs, originated from an application function (AF);
obtain subscription data for the UE or the group of UEs indicating whether the request for time synchronization from the AF is authorized to proceed;
upon determining the subscription data for the UE or the group of UEs do not authorize the request for time synchronization from the AF, reject the request for time synchronization from the AF; and
proceed with the time synchronization service upon determining the subscription data authorize the request for time synchronization service from the AF.

20. The node of claim 19, wherein the request for time synchronization service from the AF further comprises a request for time synchronization with time resiliency service and the subscription data indicate whether the request for time synchronization with time resiliency is authorized or not.

21. The node of claim 19, wherein the request for time synchronization or time synchronization with time resiliency include parameters related to requested timing resiliency service.

22. The node of claim 19, wherein, with respect to obtaining the subscription data, the one or more processors are configured to:
send a request to a User Data Management (UDM) node to request the subscription data related to time synchronization service or time synchronization with time resiliency service; and
receive the subscription data indicating whether time synchronization service is authorized, or whether time synchronization with time resiliency service is authorized.

23. The node of claim 19, wherein the subscription data comprises an indication that the time synchronization service or the time synchronization with time resiliency service is enabled or disabled.

24. The node of claim 19, wherein the one or more processors are further configured to subscribe the node at the User Data management node, to receive any changes to the subscription to time synchronization or time synchronization with time resiliency service.

25. The method of claim 12, wherein the one or more processors are further configured to receive a notification from the UDM or the AF to disable time synchronization service, and upon receiving the notification, deactivate the time synchronization service and deactivate the timing resiliency service if the time synchronization with timing resiliency was previously authorized and/or activated.
